(19) United States
(12) Patent Application Publication
(10) Pub. No.: US 2021/0293929 A1
(43) Pub. Date: Sep. 23, 2021

(54) RANGING SYSTEM AND MOBILE PLATFORM

(71) Applicant: SZ DJI TECHNOLOGY CO., LTD., Shenzhen (CN)

(72) Inventors: Shuai DONG, Shenzhen (CN); Chenghui LONG, Shenzhen (CN); Xiongze MEI, Shenzhen (CN); Xiaoping HONG, Shenzhen (CN); Fu ZHANG, Shenzhen (CN)

(21) Appl. No.: 17/339,938

(22) Filed: Jun. 4, 2021

Related U.S. Application Data
(63) Continuation of application No. PCT/CN2018/119799, filed on Dec. 7, 2018.

(51) Int. Cl. G01S 7/484; G01S 17/10

(52) U.S. Cl. CPC G01S 7/484; G01S 17/10

(57) ABSTRACT

A ranging system includes a plurality of ranging apparatuses. Each of the plurality of ranging apparatuses is configured to emit a laser pulse sequence, receive a laser pulse sequence reflected by an object, and detect the object according to the laser pulse sequence emitted and the laser pulse sequence received. The two or more ranging apparatuses of the plurality of ranging apparatuses are configured to emit laser pulse sequence with different time sequences and/or to emit different laser pulse sequences.

### CROSS-REFERENCE TO RELATED APPLICATION

This application is a continuation of International Application No. PCT/CN2018/119799, filed Dec. 7, 2018, the entire content of which is incorporated herein by reference.

### TECHNICAL FIELD

The present disclosure generally relates to the ranging apparatus technology field and, more particularly, to a ranging system and a mobile platform.

### BACKGROUND

A LIDAR plays an important role in a plurality of fields, for example, the LIDAR can be applied to a mobile platform or a non-mobile platform for remote sensing, obstacle avoidance, surveying and mapping, modeling, etc. Particularly for the mobile platform, for example, a robot, a manually operated plane, an unmanned aerial vehicle, a car, a ship, etc., navigation is performed in a complex environment by using the ranging apparatus to realize path plan, obstacle detection, obstacle avoidance, etc.

When the ranging apparatus such as the LIDAR is applied, more than one ranging apparatus will be applied in an application scene under a plurality of situations. For example, a plurality of ranging apparatuses are mounted in a car, or one or more ranging apparatuses are mounted in a plurality of mobile platforms in the environment. With such a setting, crosstalk is generated among the plurality of ranging apparatuses. That is, an optical signal emitted by a ranging apparatus is received by another ranging apparatus. Thus, a noise point is generated, and a measurement result of the ranging apparatus is affected.

### SUMMARY

Embodiments of the present disclosure provide a ranging system including a plurality of ranging apparatuses. Each of the plurality of ranging apparatuses is configured to emit a laser pulse sequence, receive a laser pulse sequence reflected by an object, and detect the object according to the laser pulse sequence emitted and the laser pulse sequence received. The two or more ranging apparatuses of the plurality of ranging apparatuses are configured to emit laser pulse sequence with different time sequences and/or to emit different laser pulse sequences.

Embodiments of the present disclosure provide a ranging system including a ranging apparatus. The ranging apparatus is configured to emit a laser pulse sequence, receive a laser pulse sequence reflected by an object, and detect the object according to the laser pulse sequence emitted and the laser pulse sequence received. The ranging apparatus is configured to emit the laser pulse sequences with a random repetition frequency and/or the laser pulse sequence after modulation.

Embodiments of the present disclosure provide a mobile platform including a first ranging apparatus and a second ranging apparatus. a ranging system including a plurality of ranging apparatuses. Each of the plurality of ranging apparatuses is configured to emit a laser pulse sequence, receive a laser pulse sequence reflected by an object, and detect the object according to the laser pulse sequence emitted and the laser pulse sequence received. The two or more ranging apparatuses of the plurality of ranging apparatuses are configured to emit laser pulse sequence with different time sequences and/or to emit different laser pulse sequences. The second ranging system includes a ranging apparatus. The ranging apparatus is configured to emit a laser pulse sequence, receive a laser pulse sequence reflected by an object, and detect the object according to the laser pulse sequence emitted and the laser pulse sequence received. The ranging apparatus is configured to emit the laser pulse sequence with a random repetition frequency and/or emit the laser pulse sequence after modulation.

### BRIEF DESCRIPTION OF THE DRAWINGS

FIG. 1A is a schematic diagram showing crosstalk between different ranging apparatuses under a first situation according to some embodiments of the present disclosure.

FIG. 1B is a schematic diagram showing crosstalk between different ranging apparatuses under a second situation according to some embodiments of the present disclosure.

FIG. 1C is a schematic diagram showing crosstalk between different ranging apparatuses under a third situation according to some embodiments of the present disclosure.

FIG. 1D is a schematic diagram showing crosstalk between different ranging apparatuses under a fourth situation according to some embodiments of the present disclosure.

FIG. 1E is a schematic diagram showing crosstalk between different ranging apparatuses under a fifth situation according to some embodiments of the present disclosure.

FIG. 1F is a schematic diagram showing crosstalk between different ranging apparatuses under a sixth situation according to some embodiments of the present disclosure.

FIG. 1G is a schematic diagram showing continuous pulses of LIDAR A being received by LIDAR B according to some embodiments of the present disclosure.

FIG. 2 is a schematic diagram showing different LIDARs emitting light pulse sequences with different time sequences according to some embodiments of the present disclosure.

FIG. 3 is a schematic diagram showing different LIDARs emitting light pulse sequences with different repetition frequencies according to some embodiments of the present disclosure.

FIG. 4 is a schematic diagram showing different LIDARs emitting light pulse sequences with random frequencies according to some embodiments of the present disclosure.

FIG. 5 is a schematic diagram showing different LIDARs emitting light pulses with different wavelengths according to some embodiments of the present disclosure.

FIG. 6 is a schematic diagram showing different LIDARs emitting light pulse sequences with different wave shapes according to some embodiments of the present disclosure.

FIG. 7 is a schematic architectural diagram of a ranging apparatus according to some embodiments of the present disclosure.

FIG. 8 is a schematic diagram of the ranging apparatus according to some embodiments of the present disclosure.

### DETAILED DESCRIPTION OF THE EMBODIMENTS

To make purposes, technical solutions, and advantages of the present disclosure clearer, embodiments of the present disclosure are described in conjunction with the accompanying drawings below. The described embodiments are only some embodiments not all the embodiments of the present disclosure. The present disclosure is not limited by embodiments described here. Based on the embodiments of the disclosure, all other embodiments obtained by those of ordinary skill in the art without any creative work are within the scope of the present disclosure.

In the following description, a lot of specific details are given to provide a more thorough understanding of the present disclosure. However, it is obvious to those skilled in the art that the present disclosure can be implemented without one or more of these details. In other examples, to avoid confusion with the present disclosure, some technical features known in the art are not described.

The present disclosure may be implemented in different forms and should not be understood to be limited by the described embodiments. On contrary, providing these embodiments will cause the present disclosure to be thorough and complete, and will fully convey the scope of the present disclosure to those skilled in the art.

Terms used in the present disclosure describe merely specific embodiments but are not intended to limit the present disclosure. The singular forms of “a,” “one,” and “said/the” used in the present disclosure and the appended claims are also intended to include plural forms unless the context indicates other meanings. When the terms “including” and/or “containing” are used in the specification, the existence of the described features, integers, steps, operations, elements, and/or components is determined, but do not exclude the existence or addition of one or more other features, integers, steps, operations, elements, and/or components. As used herein, the term “and/or” includes any and all combinations of related listed items.

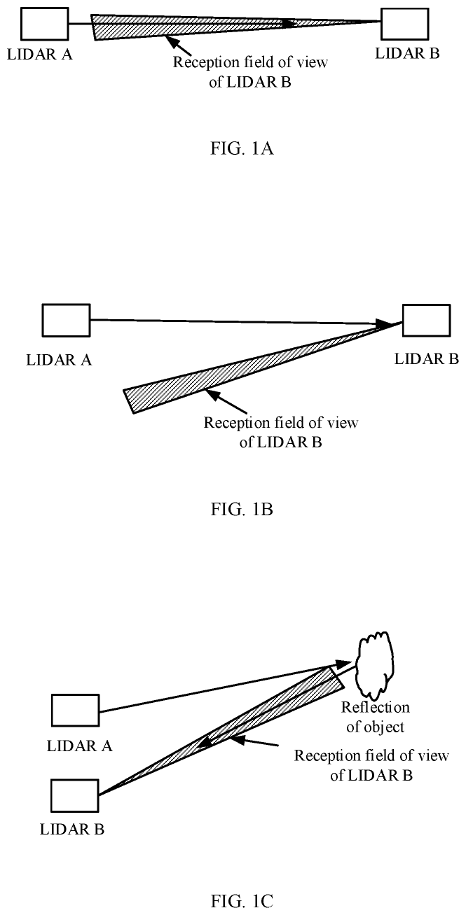

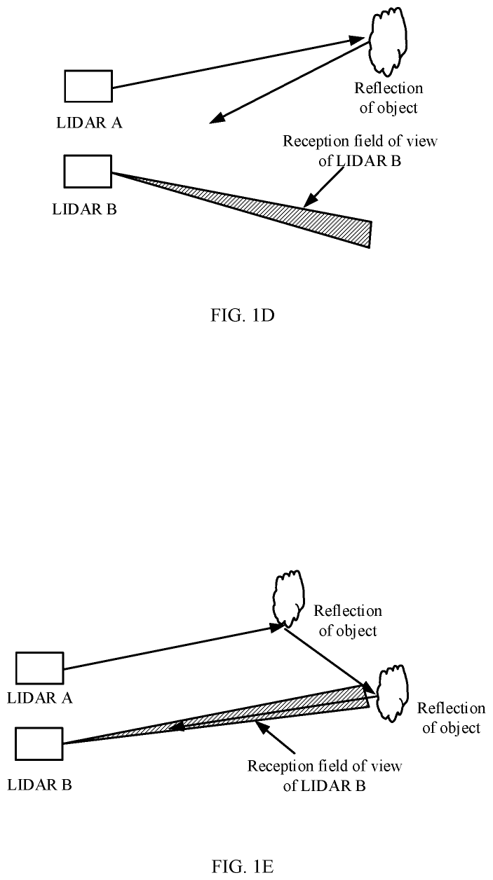

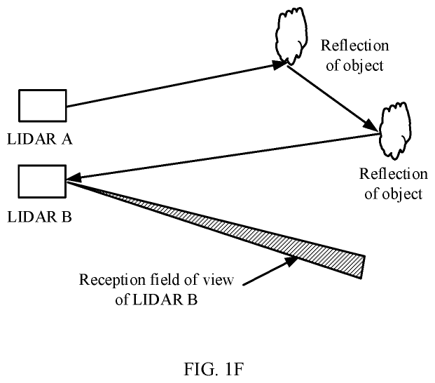

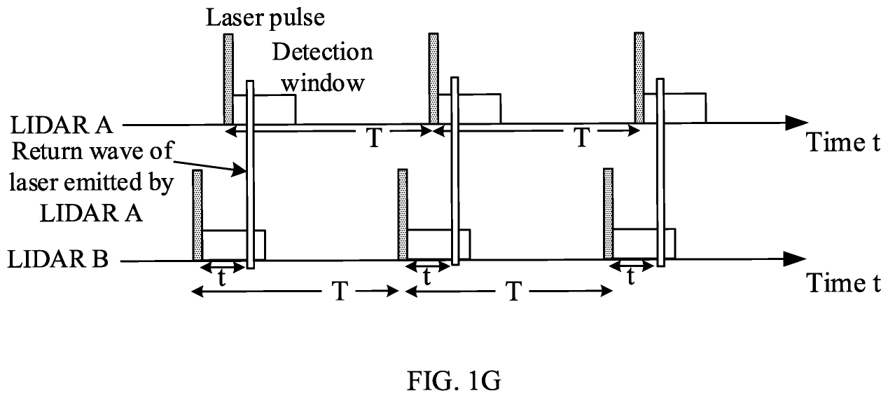

When a ranging apparatus such as a LIDAR is used, in many cases, more than one ranging apparatus will be applied in an application scene. For example, a plurality of ranging apparatuses are mounted in a car, or one or more ranging apparatuses are mounted in a plurality of mobile platforms in the environment. With such a setting, crosstalk may be generated among the plurality of ranging apparatuses. That is, an optical signal emitted by a ranging apparatus may be received by another ranging apparatus. Thus, a noise point may be generated. In connection with FIG. 1A to FIG. 1G, the crosstalk problem among the plurality of ranging apparatuses such as the LIDARs are explained and described.

Under a first situation shown in FIG. 1A, a light pulse emitted by LIDAR A is in a reception field of view of LIDAR B and received by LIDAR B. Noise is generated.

Under a second situation shown in FIG. 1B, a light pulse emitted by LIDAR A is projected at LIDAR B and is not in the reception field of view of LIDAR B. However, the light pulse emitted by LIDAR A may be reflected by various structures inside LIDAR B and eventually received by a detector inside LIDAR B (an optical signal received by LIDAR B being generated by structural scattering, referred to as “stray light” below). Noise is generated.

Under a third situation shown in FIG. 1C, a position of an object where a light pulse emitted by LIDAR A is projected is in the reception field of view of LIDAR B. The light pulse emitted by LIDAR A is received by LIDAR B after reflected by the object. Noise is generated.

Under a fourth situation shown in FIG. 1D, a position of an object where a light pulse emitted by LIDAR A is projected is not in the reception field of view of LIDAR B. The light pulse emitted by LIDAR A is projected to LIDAR B after being reflected by the object and received as stray light by the detector of LIDAR B. Noise is generated.

Under a fifth situation shown in FIG. 1E, a light pulse emitted by LIDAR A appears in the reception field of view of LIDAR B and is received by LIDAR B after being projected to and reflected multiple times by objects. Noise is generated.

Under a sixth situation shown in FIG. 1F, after being projected to and reflected multiple times by objects, the light pulse emitted by LIDAR A appears in the reception field of view of LIDAR B and is received by LIDAR B. Noise is generated.

In the first to third situations, since LIDARs are scanning, the noise in LIDAR B may be isolated (i.e., neighboring light pulses do not generate noise points simultaneously).

In the second, the fourth, and the sixth situations, the light pulse emitted by LIDAR A or the light pulse emitted by LIDAR A reflected by the object is not in the reception field of view of LIDAR B. However, the light pulse may be projected at LIDAR B, reflected/scattered inside LIDAR B, and eventually received by LIDAR B to generate noise points.

In the fourth and sixth situations, since the light pulses emitted by LIDAR A are received by LIDAR B as stray light, and within a short time, an emission direction of LIDAR A and an orientation of the reception field of view of LIDAR B have a relatively small change, a series of continuous light pulses emitted by LIDAR A may all generate noise points in LIDAR B with basically a same distance to form continuous noise points as shown in FIG. 1G.

For the above situations, embodiments of the present disclosure provide several methods to reduce or avoid the crosstalk between the LIDARs or reduce the impact of the crosstalk. The solution of the present disclosure can solve the above listed several kinds of crosstalk problems and a crosstalk problem among a plurality of ranging apparatuses under another situation.

To understand the present disclosure, a detailed structure is provided in the following description to explain the solution provided by the present disclosure. Embodiments of the present disclosure are described in detail below. However, in addition to these detailed descriptions, the present disclosure may further include other embodiments.

To solve the above problems, the present disclosure provides a ranging system including at least two ranging apparatuses configured to emit laser pulse sequences, receive laser pulse sequences reflected by an object, and detect the object according to the laser pulse sequences emitted and the laser pulse sequences received. At least part of the at least two ranging apparatuses emit laser pulse sequences with different time sequences and/or emit different laser pulse sequences.

The ranging system of the present disclosure may include the at least two ranging apparatuses. The at least part of the at least two ranging apparatuses may emit the laser pulse sequences with different time sequences to cause an interval between emission times of two neighboring laser pulse sequences emitted by the at least part of the at least two ranging apparatuses. As flight time increases, power of a light pulse from another ranging apparatus due to crosstalk received by a ranging apparatus may be smaller. Thus, probability of generating a crosstalk noise may be reduced correspondingly. After a ranging apparatus receives a laser pulse, time of the ranging apparatus emitting the laser pulse may be used as a basis for measuring the flight time of the laser pulse. Therefore, for a received crosstalk light pulse signal, the time measured by the ranging apparatus may be changing. That is, crosstalk noises caused by other ranging apparatuses for the ranging apparatus may have different depths. Thus, the crosstalk may be filtered out easily through an algorithm.

The at least two ranging apparatuses included in the ranging system of the present disclosure may be configured that the at least part of the at least two ranging apparatuses may emit the different laser pulse sequences. Through such a setting, the laser pulse sequences emitted by different ranging apparatuses may be distinguished. As such, the different ranging apparatuses may receive the laser pulses emitted by themselves to reduce or eliminate the probability of generating the crosstalk noise.

In connection with the accompanying drawings, the ranging system of the present disclosure is described in detail. When there is no conflict, embodiments and features of embodiments may be combined with each other.

For example, the ranging system of the present disclosure may include the at least two ranging apparatuses. A ranging apparatus may be configured to emit a laser pulse sequence, receive a laser pulse sequence reflected by an object, detect the object according to the laser pulse sequence emitted (also referred to as an “emitted laser pulse sequence”) and the laser pulse sequence received (also referred to as a “received laser pulse sequence”). The ranging apparatus may include a LIDAR or another appropriate light ranging apparatus.

A number of the at least two ranging apparatuses may be 2, 3, 4, 5, or more. The at least two ranging apparatuses may be arranged at different mobile platforms or a same mobile platform. The platform may include a mobile platform moving in the air or on the ground, such as an unmanned aerial vehicle, a robot, a car, or a ship.

In some embodiments, the at least two ranging apparatuses may include two neighboring ranging apparatuses arranged on a same platform. Since the two ranging apparatuses are neighboring and close to each other, a laser pulse sequence emitted by one of the two ranging apparatuses may be received by the other one of the two ranging apparatuses. Thus, crosstalk may be generated easily.

In some other embodiments, the at least two ranging apparatuses may include two ranging apparatuses that are arranged on the same platform, and the field of views (FOVs) of the two ranging apparatuses may have an overlapped portion. The two ranging apparatuses may be neighboring ranging apparatuses or ranging apparatuses spaced apart. Since the FOVs of the ranging apparatuses have the overlapped portion, the crosstalk problem may be easily generated.

In some other embodiments, the at least two ranging apparatuses may include two ranging apparatuses arranged on the same mobile platform having a same detection direction or two ranging apparatuses arranged on a same side of the same mobile platform. The crosstalk problem may be easily generated between the two ranging apparatuses according to the setting manner.

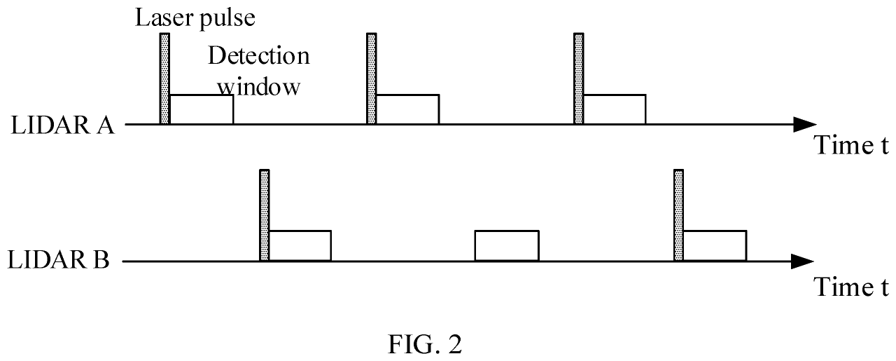

For example, to reduce or eliminate the crosstalk, the at least part of the ranging apparatuses of the at least two ranging apparatuses may emit the laser pulse sequences with different time sequences. In some embodiments, referring to FIG. 2 to FIG. 4, some embodiments of the at least part of the at least two ranging apparatuses emitting the laser pulse sequences with different time sequences are described and explained in detail. To facilitate explanation and description, the accompanying drawings only show a situation that the ranging system includes LIDAR A and LIDAR B.

In some embodiments, the at least part of the at least two ranging apparatuses emitting the laser pulse sequences with different time sequences includes a time interval between emission time of the laser pulse sequence of one ranging apparatus of the at least two ranging apparatuses and detection window of the laser pulse sequence of another ranging apparatus of the at least two ranging apparatuses. In some embodiments, the time interval ranging apparatus may exist between the emission time of the laser pulse sequence of the one ranging apparatus of the at least two ranging apparatuses and the mission time of the laser pulse sequence of another ranging apparatus of the at least two ranging apparatuses (i.e., emission times of the two ranging apparatuses are staggered). That is, the time interval may exist between the emission time of the laser pulse sequence of one ranging apparatus of the at least two ranging apparatuses and a start point of a detection window of the another ranging apparatus. The time interval may be appropriately set according to the actual needs of the ranging apparatuses. For example, the time interval may range from 1/10 to ½ of a pulse repetition interval (PRI) of the ranging apparatuses.

In some embodiments, a detection window of the one ranging apparatus of the at least two ranging apparatuses may be completely staggered from a detection window of the another ranging apparatus of the at least two ranging apparatuses (i.e., the two detection windows do not overlap with each other). That is, a time interval may exist between the emission time of the laser pulse sequence of the one ranging apparatus and an endpoint of the detection window of the another ranging apparatus. For example, as shown in FIG. 2, emission times of LIDAR A and LIDAR B may be controlled to cause the laser pulse emitted by LIDAR A and the detection window of LIDAR B to have a relatively large time difference. For example, the detection window of LIDAR A may be completely staggered from the detection window of LIDAR B.

In the specification, a detection window may refer to a time window of each ranging apparatus from emission of a laser pulse sequence to reception of a farthest reflected laser pulse sequence.

Through such a setting, for a laser pulse sequence emitted by a ranging apparatus to be detected by another ranging apparatus, the laser pulse sequence may need to fly for a longer time. That is, a distance that the laser pulse sequence travels in the space may be longer, which may reduce the power of the laser pulse sequence. Therefore, the probability of generating the crosstalk noise may be correspondingly reduced mainly for the following two reasons.

A first reason includes that if a situation is similar to the first crosstalk situation or the second crosstalk situation, since the laser pulse sequence has a certain divergence, the longer the distance is, the larger a light spot is, and the more scattered energy is distributed in the space. Therefore, a proportion of optical power of the one ranging apparatus received by the another ranging apparatus may be also smaller. For example, as shown in FIG. 2, the proportion of the optical power of LIDAR A received by LIDAR B is also smaller.

A second reason includes that if a situation is similar as the third to the sixth crosstalk situations, the another ranging apparatus (e.g., LIDAR B) receives reflected light of the laser pulse sequence emitted by the one ranging apparatus (e.g., LIDAR A) after being diffusely reflected by the object. Since diffusely reflected light is transmitted in all directions in space, as a distance between the another ranging apparatus (e.g., LIDAR B) and a reflection position increases, a proportion of the reflected light received by the another ranging apparatus (e.g., LIDAR B) also decreases, which is inversely proportional to the square of the distance.

Therefore, as the flight time increases, laser power received by LIDAR B from LIDAR A due to the crosstalk is also smaller. Thus, the probability of generating the crosstalk noise will be correspondingly reduced.

To control the time sequence of the at least two ranging apparatuses simultaneously, the ranging system may further include a controller. The at least two ranging apparatuses may be electrically connected to the same controller to control the time sequence of each ranging apparatus.

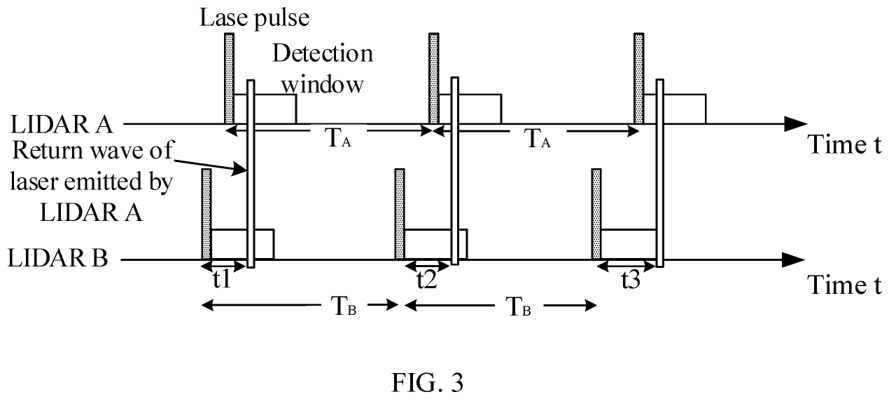

In some other embodiments, the at least part of the at least two ranging apparatuses emitting the laser pulse sequences with different time sequences includes the at least part of the at least two ranging apparatuses emitting the laser pulse sequences in different repetition frequencies to cause at least part of pulse emission times of the at least part of the at least two ranging apparatuses to be staggered. For example, as shown in FIG. 3, time interval TA of LIDAR A emitting the laser pulses is larger than time interval TB of LIDAR B emitting the laser pulses. That is, the repetition frequency of LIDAR A is smaller than the repetition frequency of LIDAR B. The different laser pulses emitted by LIDAR A may reach LIDAR B after being transmitted for almost the same time. However, since the interval of the pulse emission time of LIDAR B and the pulse emission time of LIDAR A is changing, and the pulse emission time of LIDAR B is used as a basis for measuring the flight time after LIDAR B receives the light pulses, measurement time of LIDAR B for the received crosstalk light pulse signal may be changing. For example, for t1, t2, and t3 shown in FIG. 3, as reflected in the result of the measurement, the crosstalk noises at LIDAR B caused by LIDAR A have different depths. The noises may be easily eliminated through the algorithm. Such a method may convert continuous noise points into discrete noise points, which may be easily identified and eliminated.

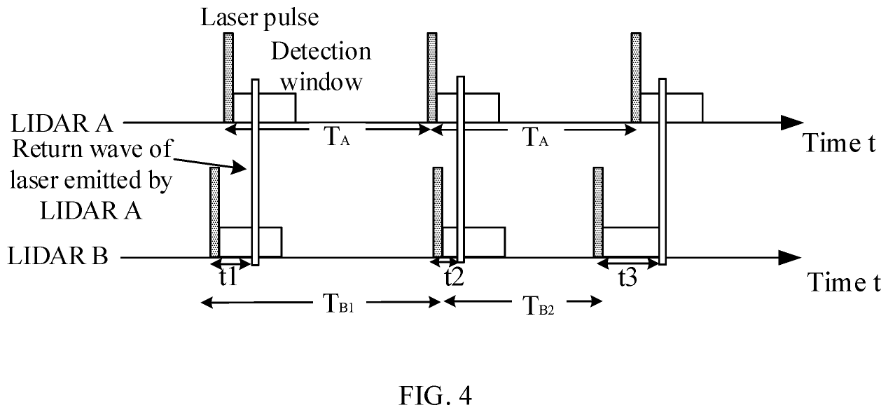

In some embodiments, the at least part of the at least two ranging apparatuses emitting the laser pulse sequences with different time sequences includes at least one of the at least two ranging apparatuses emitting the laser pulse sequences with random repetition frequencies. In some embodiments, each ranging apparatus may emit the laser pulse sequences with the random repetition frequencies. Emitting the laser pulse sequences with the random repetition frequencies may refer to that the time interval of the ranging apparatus emitting a pulse and a next pulse is random. For example, LIDAR B shown in FIG. 4 emits the laser pulse sequences with the random repetition frequencies. The time intervals for emitting the laser pulse sequences are different, a former one is T_{B1} and a latter one is T_{B2}.

In some other embodiments, the at least part of the at least two ranging apparatuses emitting the laser pulse sequences with different time sequences includes the at least part of the at least two ranging apparatuses emitting the laser pulse sequences at a same repetition frequency, and another part of the at least two ranging apparatuses emitting the laser pulse sequences at random repetition frequencies. For example, as shown in FIG. 4, LIDAR A emits the laser pulse sequences at the same repetition frequency. LIDAR B emits the laser pulse sequences at the random repetition frequencies. The laser pulses emitted by LIDAR A may reach LIDAR B after being transmitted for almost the same time. However, the time interval between the pulse emission time of LIDAR B and the pulse emission time of LIDAR A is changing, and the pulse emission time of LIDAR B is used as the basis after LIDAR B receives the light pulse, the measurement time of LIDAR B for the received crosstalk light pulse signal may be also changing. For example, for t1, t2, and t3 shown in FIG. 3, as reflected in the result of the measurement, the crosstalk noises at LIDAR B caused by LIDAR A have different depths. The noises may be easily eliminated through algorithm. Such a method may convert the continuous noise points into discrete noise points, which may be easily identified and eliminated.

In some other embodiments, the at least part of the at least two ranging apparatuses emitting the laser pulse sequences with different time sequences includes a part of the at least two ranging apparatuses emitting the laser pulse sequences at the different repetition frequencies and another part of the at least two ranging apparatuses emitting the laser pulse sequences at the random repetition frequencies.

In the above manner, since the time interval between the pulse emission time of the one ranging apparatus and the pulse emission time of the another ranging apparatus is changing, after the another ranging apparatus receives the light pulse, the flight time of the light pulse may be measured by using the pulse emission time of the light pulse as the basis. Therefore, for the received crosstalk light pulse signal, the measurement time of the another ranging apparatus may be changing. As a measurement result, the crosstalk noises caused by the one ranging apparatus to the another ranging apparatus may have different depths. The noises may be easily eliminated through the algorithm. Such a method may convert the continuous noise points into discrete noise points. Thus, the noise may be easily identified and eliminated.

In the specification, a pulse repetition frequency (PRF) is a number of pulses emitted in each second, which is the reciprocal of the pulse repetition interval (PRI). The PRI refers to a time interval between a pulse and a next pulse.

In some embodiments, the at least part of the at least two ranging apparatuses may emit different laser pulse sequences. For example, the laser pulse sequences emitted by the at least part of the at least two ranging apparatuses may be distinguished in a frequency domain (e.g., wavelength) or may be marked with a distinguishing mark to cause the ranging apparatuses to recognize the laser pulse sequences emitted by themselves.

In some embodiments, the at least part of the at least two ranging apparatuses emitting the different laser pulse sequences includes that the at least two ranging apparatuses are divided into at least two groups, and ranging apparatuses of different groups emit laser pulse sequences with different wavelengths. The ranging apparatuses may be appropriately divided according to the number of the ranging apparatuses included in the ranging system. Each group of ranging apparatuses may include at least one ranging apparatus. In some embodiments, different ranging apparatuses in a same group may emit the laser pulse sequences with the same wavelength, or ranging apparatuses of a part of the at least two groups may emit the laser pulse sequences with the same wavelength, and ranging apparatuses of another group may emit the laser pulse sequences with different wavelengths.

In some embodiments, a ranging apparatus that causes the crosstalk may be further configured to emit the laser pulse sequences with different wavelengths.

In some embodiments, different ranging apparatuses of the at least two ranging apparatuses may emit the laser pulse sequences with different wavelengths, which may be determined according to the actual number of the ranging apparatuses. A ranging apparatus can emit the laser pulse sequences with limited kinds of wavelengths, which may be limited by a type and material of a laser device. Since the ranging apparatus may equivalently isolate different ranging apparatuses using different wavelengths, each ranging apparatus may only detect a wavelength of light emitted by itself and is not affected by another ranging apparatus. Thus, the crosstalk may be effectively avoided.

In some embodiments, each ranging apparatus may further include a filter (not shown). The filter may be configured to perform light filtering on the laser pulse sequence reflected by the object to filter out at least a part of light with wavelengths of a non-operational range.

In some embodiments, the ranging apparatus may further include a collimation lens and a convergence lens. The collimation lens may be located on an emission optical path of an emitter. The collimation lens may be configured to collimate the laser pulse sequence emitted by the emitter and transmit the collimated laser pulse sequence from the ranging apparatus. The convergence lens may be configured to converge at least a part of return light reflected by the object. The collimation lens and the convergence lens may be two independent convex lenses or a convex lens, e.g., a same convex lens.

In some embodiments, a bandwidth of the filter may be consistent with a bandwidth of the laser pulse sequence emitted by each ranging apparatus. The filter may filter light outside of the bandwidth of an emitted beam to filter out at least a part of natural light of the return light. Since the laser pulse sequences emitted by different ranging apparatuses have different wavelengths, the laser pulse sequence emitted by another ranging apparatus may be filtered out to reduce interference of light with non-operational wavelength range on detection.

Since the filter light spectrum of the filter may drift as an incident angle of an incident beam changes, in some embodiments, the filter may be located on a side of the convergence lens face away from the detection module. That is, the filter may filter the reflected laser pulse sequence and be located on an optical path that the reflected laser pulse does not reach the convergence lens. As such, the incident angle of the return light that is not converged by the convergence lens may be better consistent than the incident angle of the return light converged by the convergence lens. Thus, the drift of the filter light spectrum caused by the changes of the incident angle may be reduced.

In some embodiments, the filter may be made using a film material with a high refractive index to obtain a beneficial effect that a center wavelength has a relatively small deviation when the incident angle is large. For example, the spectrum of the incident light with the incident angle from 0° to 30° has a deviation smaller than a certain value (e.g., 12 nm). In some embodiments, the filter may include a bandpass filter or another appropriate filter.

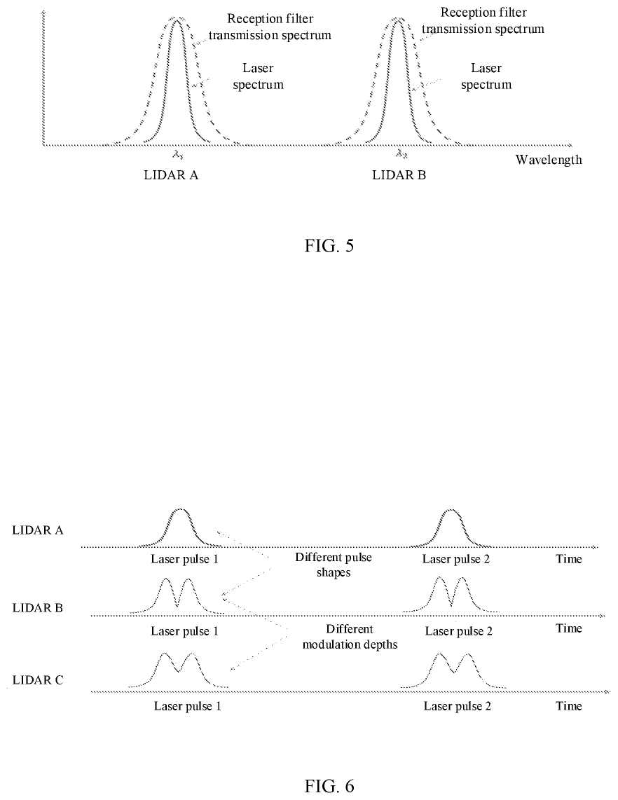

In some embodiments, as shown in FIG. 5, the ranging system includes LIDAR A and LIDAR B. The LIDARs may use different wavelengths to equivalently isolate different LIDARs. That is, each LIDAR may only detect the wavelength emitted by itself and may not be affected by another LIDAR.

For example, LIDAR A may emit a laser with a wavelength of Δ₁±Δλ₁, and a filter such as a bandpass filter corresponding to LIDAR A may be arranged on its optical path. That is, the laser with the wavelength of Δ₁±Δλ₁* may have a high transmission rate, and the laser with another wavelength may have a low transmission rate.

LIDAR B may emit a laser with a wavelength of Δ₂±Δλ₂, and a bandpass filter having a corresponding parameter may be arranged on the optical path of LIDAR B. That is, a laser with a wavelength of λ₂±Δλ₂* may have a high transmission rate, and a laser with another wavelength may have a low transmission rate. Under such configuration, for the first to sixth crosstalk situations, no matter whether LIDAR A is in the reception FOV of LIDAR B, since there is an optical filter, the laser emitted by LIDAR A may be attenuated greatly at a LIDAR B end. Thus, no crosstalk will be generated at the LIDAR B end.

In some other embodiments, the at least part of the at least two ranging apparatuses emitting different laser pulse sequences includes the at least part of the at least two ranging apparatuses emitting the laser pulse sequences having different pulse wave shapes. In some embodiments, the different pulse wave shapes may include pulse wave shapes having different time domain features or pulse wave shapes having different pulse widths. In some other embodiments, the different pulse wave shapes may include pulse wave shapes having different modulation depths. By marking the laser pulse sequences emitted by the different ranging apparatuses in the time domain with the distinguishing marks, the different ranging apparatuses may recognize the pulses emitted by themselves. Thus, nearly no mutual crosstalk may exist among many ranging apparatuses.

In some embodiments, as shown in FIG. 6, the ranging system include LIDAR A, LIDAR B, and LIDAR C. Laser pulses emitted by LIDAR A and LIDAR B have different pulse wave shapes of different time-domain features including pulse width, a pulse time-domain modulation feature (modulation wave shape, modulation depth, etc.). For example, as shown in FIG. 6, LIDAR A and LIDAR B emit the laser pulse sequences having different pulse wave shapes. LIDAR B and LIDAR C emit the laser pulse sequences having different modulation depths. Distinguishing marks may be marked on the laser pulses emitted by LIDAR A, LIDAR B, and LIDAR C in the time domain to cause them to recognize the laser pulses emitted by themselves. Thus, the mutual crosstalk may be avoided.

In some other embodiments, the laser pulse sequences emitted by the different ranging apparatuses may also be distinguished by code division multiplexing technology, so that there is basically no crosstalk between the plurality of ranging apparatuses.

In some other embodiments, the ranging system may include at least one ranging apparatus. the ranging apparatus may be configured to emit the laser pulse sequence, receive the laser pulse sequence reflected by the object, and detect the object according to the emitted laser pulse sequence and the received laser pulse sequence. The at least one ranging apparatus may emit the laser pulse sequence with the random repetition frequency. By using the ranging apparatus to emit the laser pulse sequence with the random repetition frequency, the crosstalk problem may be avoided when the ranging apparatus is applied in a situation including another ranging apparatus.

In some embodiments, the at least one ranging apparatus may emit a modulated laser pulse sequence. The modulated laser pulse sequence may include the different time domains or time-domain features. Thus, the crosstalk problem may also be avoided when the ranging apparatus is applied in a situation including another ranging apparatus.

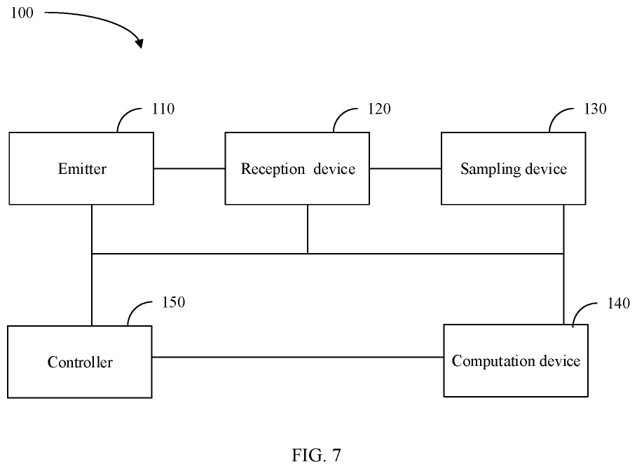

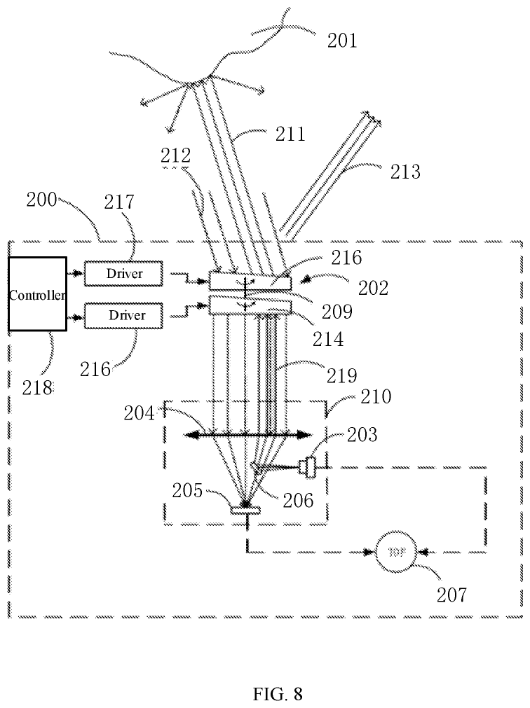

Referring to FIG. 7 and FIG. 8, a structure of a ranging apparatus of embodiments of the present disclosure is described exemplarily. The ranging apparatus includes a LIDAR. The ranging apparatus is merely an example. Another appropriate ranging apparatus may be also applied in the present disclosure.

Various circuits of embodiments of the present disclosure may be applied in the ranging apparatus. The ranging apparatus may include an electronic apparatus such as a LIDAR, a laser ranging apparatus, etc. In some embodiments, the ranging apparatus may be configured to sense external environment information, for example, distance information of an environment target, orientation information, reflection intensity information, speed information, etc. In some embodiments, the ranging apparatus may be configured to detect a distance from a detected object to the ranging apparatus by measuring light transmission time, i.e., time-of-flight (TOF), between the ranging apparatus and the detected object. In some other embodiments, the ranging apparatus may be configured to detect the distance from the detected object to the ranging apparatus through another technology, for example, a ranging method based on phase shift measurement or frequency shift measurement, which is not limited here.

To facilitate understanding, an operation process for ranging is described as an example in connection with a ranging apparatus 100 shown in FIG. 7.

As shown in FIG. 7, the ranging apparatus 100 includes an emitter 110, a reception device 120, a sampling device 130, and a computation device 140.

The emitter 110 may include a laser device, a switch device, and a driver. The laser device may include a diode, for example, a positive-intrinsic-negative (PIN) diode. The laser device may emit a laser pulse sequence with a certain wavelength. The laser device may be referred to as a light source or an emission light source.

The switch device may be a switch device of the laser device, which may be connected to the laser device and configured to control the laser device to be on/off. When the laser device is on, the laser device may emit the laser pulse sequence. When the laser device is off, the laser device may not emit the laser pulse sequence. The driver may be connected to the switch device and configured to drive the switch device.

In some embodiments, the switch device may include a metal-oxide-semiconductor field-effect transistor (MOSFET). The driver may include a MOS driver, which may be configured to drive the MOSFET that is configured as the switch device. The MOSFET may control the laser device to be on/off.

The switch device may further include a gallium nitride (GaN) transistor. The driver may include a GaN driver.

The emitter 110 may be configured to emit a light pulse sequence (e.g., a laser pulse sequence). The reception device 120 may be configured to receive the light pulse sequence reflected by the detected object, perform photoelectric conversion on the light pulse sequence to obtain an electrical signal, and output the processed electrical signal to the sampling device 130. The sampling device 130 may be configured to perform sampling on the electrical signal to obtain a sampling result. The computation device 140 may be configured to determine the distance between the ranging apparatus 100 and the detected object based on the sampling result of the sampling device 130.

In some embodiments, the ranging apparatus 100 further includes a control circuit 150. The control circuit 150 may be configured to control another module or circuit. For example, the control circuit 150 may be configured to control the operation time of the modules and circuits and/or perform parameter setting on the modules and the circuits.

Although the ranging apparatus shown in FIG. 7 includes the emitter, the reception device, the sampling device, and the computation device and is configured to emit a beam for detection, the present disclosure is not limited to this. A quantity of any one circuit of the emitter, the reception device, the sampling device, and the computation device may be at least two. The ranging apparatus may be configured to emit at least two beams along a same direction or different directions. The at least two beams may be emitted simultaneously or at different times. In some embodiments, light-emitting dies of the at least two emitters may be packaged in a same module. For example, each emitter may include a laser emission die. The laser emission dies of the at least two emitters may be packaged together and accommodated in a same package space.

In some embodiments, in addition to the structure shown in FIG. 7, the ranging apparatus 100 further includes a scanner, which may be configured to change the transmission direction of the at least one light pulse sequence emitted by the emitter for transmission.

A module that includes the emitter 110, the reception device 120, the sampling device 130, and the computation device 140, or a module that includes the emitter 110, the reception device 120, the sampling device 130, the computation device 140, and the control circuit 150 may be referred to as a ranging device. The ranging device may be independent of another module, for example, a scanner.

In some embodiments, a co-axial optical path may be used in the ranging apparatus. That is, the beam emitted from the ranging apparatus and a beam reflected may share at least a part of the optical path in the ranging apparatus. For example, the at least one beam of the light pulse sequence emitted by the emitter may be emitted after the transmission direction of the at least one beam of the light pulse sequence is changed by the scanner. The light pulse sequence reflected by the detected object may enter into the reception device through the scanner. In some other embodiments, off-axial optical paths may be used in the ranging apparatus. That is, the beam emitted by the ranging apparatus and the beam reflected may be transmitted along different paths in the ranging apparatus. FIG. 8 is a schematic diagram of a ranging apparatus 200 using a coaxial optical path according to some embodiments of the present disclosure.

The ranging apparatus 200 includes a ranging device 210. The ranging device 210 includes an emitter 203 (including the emission device), a collimation element 204, a detector 205 (including the reception device, the sampling device, and the computation device), and an optical path change element 206. The ranging device 210 may be configured to emit a beam, receive a returned beam, and convert the returned beam into an electrical signal. The emitter 203 may be configured to emit an optical pulse sequence. In some embodiments, the emitter 203 may emit a light pulse sequence. In some embodiments, the laser beam emitted by the emitter 203 may include a narrow bandwidth beam with a wavelength outside of a visible light range. The collimation element 204 may be arranged on an emission path of the emitter 203 and further configured to collimate the beam emitted from the emitter 203 into parallel light to emit to the scanner. The collimation element 204 may be further configured to converge at least a part of the returned beam reflected by the detected object. The collimation element 204 may include a collimation lens or another element that can collimate the beam.

In some embodiments shown in FIG. 8, an emission optical path and a reception optical path of the ranging apparatus may be combined through the optical path change element 206 before the collimation element 204. Thus, the emission optical path and the reception optical path may share the same collimation element to cause the optical path to be more compact. In some other embodiments, each of the emitter 203 and the detector 205 may include a collimation element 204. The optical path change element 206 may be arranged at the optical path after the collimation element 204.

In some embodiments shown in FIG. 8, since a diameter of a beam hole of the emitter 203 for emitting the beam is relatively small, and a diameter of a beam hole of the ranging apparatus for receiving the returned beam is relatively large, the optical path change element may use a reflection mirror with a small area to combine the emission optical path and the reception optical path. In some other embodiments, the optical path change element may also include a reflection mirror with a through-hole. The through-hole may be configured to transmit the emitted beam of the emitter 203. The reflection mirror may be configured to reflect the returned beam to the detector 205. As such, when a small reflection mirror is used, shielding of the returned beam by the holder of the small reflection mirror may be reduced.

In some embodiments shown in FIG. 8, the optical path change element 206 may be off the optical path of the collimation element 204. In some other embodiments, the optical path change element 206 may be located on the optical path of the collimation element 204.

The ranging apparatus 200 further includes a scanner 202. The scanner 202 is arranged at the emission optical path of the ranging device 210. The scanner 202 may be configured to change a transmission direction of a collimated beam 219 emitted through the collimation element 204 and project to an external environment, and project the returned beam to the collimation element 204. The returned beam may be converged at the detector 205 through the collimation element 204.

In some embodiments, the scanner 202 may include at least one optical element, which may be configured to change the transmission direction of the beam. The optical element may be configured to change the transmission direction of the beam by performing reflection, refraction, and diffraction on the beam. For example, the scanner 202 may include a lens, a reflection mirror, a prism, a galvanometer, a grating, a liquid crystal, an optical phased array, or any combination thereof. In some embodiments, at least a part of the optical elements may be movable. For example, at least a part of the optical elements may be driven to move by a drive module. The movable optical elements may reflect, refract, and diffract the beam to different directions at different times. In some embodiments, a plurality of optical elements of the scanner 202 may rotate or vibrate around a shared axis 209. Each rotating or vibrating optical element may be configured to continuously change a transmission direction of an incident beam. In some embodiments, the plurality of optical elements of the scanner 202 may rotate at different rotation speeds or vibrate at different speeds. In some other embodiments, at least the part of the optical elements of the scanner 202 may rotate at a nearly same rotation speed. In some other embodiments, the plurality of optical elements of the scanner may rotate around different rotation axes. In some other embodiments, the plurality of optical elements of the scanner may rotate in a same direction or in different directions, or vibrate in a same direction or different directions, which is not limited here.

In some embodiments, the scanner 202 includes a first optical element 214 and a driver 216 connected to the first optical element 214. The driver 216 may be configured to drive the first optical element 214 to rotate around the rotation axis 209 to cause the first optical element 214 to change the direction of the collimated beam 219. The first optical element 214 may project the collimated beam 219 in different directions. In some embodiments, an included angle between the direction of the collimated beam 219 after the first optical element and the rotation axis 209 may change as the first optical element 214 rotates. In some embodiments, the first optical element 214 includes a pair of opposite surfaces that are not parallel. The collimated beam 219 may pass through the pair of surfaces. In some embodiments, the first optical element 214 may include at least a lens, whose thickness changes along a radial direction. In some embodiments, the first optical element 214 may include a wedge prism, which may be configured to refract the collimated beam 219.

In some embodiments, the scanner 202 further includes a second optical element 215. The second optical element 215 may rotate around the rotation axis 209. The second optical element 215 and the first optical element 214 may have different rotation speeds. The second optical element 215 may be configured to change the direction of the beam projected by the first optical element 214. In some embodiments, the second optical element 215 may be connected to another driver 217. The driver 217 may be configured to drive the second optical element 215 to rotate. The first optical element 214 and the second optical element 215 may be driven by the same driver or different drivers to cause the rotation speeds and/or the rotation directions of the first optical element 214 and the second optical element 215 to be different. Thus, the collimated beam 219 may be projected to different directions of external space to scan a relatively large space area. In some embodiments, a controller 218 may be configured to control the drivers 216 and 217 to drive the first optical element 214 and the second optical element 215, respectively. The rotation speeds of the first optical element 214 and the second optical element 215 may be determined according to an expected scan area and style in practical applications. The drivers 216 and 217 may include motors or other drivers.

In some embodiments, the second optical element 215 may include a pair of opposite surfaces that are not parallel. The beam may pass through the pair of surfaces. In some embodiments, the second optical element 215 may include at least a lens whose thickness changes along a radial direction. In some embodiments, the second optical element 215 may include a wedge prism.

In some embodiments, the scanner 202 may include a third optical element (not shown in the figure) and a driver for driving the third optical element. In some embodiments, the third optical element may include a pair of opposite surfaces that are not parallel. The beam may pass through the pair of surfaces. In some embodiments, the third optical element may include at least a lens whose thickness changes along a radial direction. In some embodiments, the second optical element 215 may include a wedge prism. At least two of the first optical element, the second optical element, and the third optical element may rotate at different rotation speeds and/or in different directions.

The optical elements of the scanner 202 may rotate to project a beam to different directions, for example, a direction 213 of the projected beam 211. As such, the scanner 202 may scan the space around the ranging apparatus 200. When the projected beam 211 of the scanner 202 encounters the detected object 201, a part of the beam may be reflected by the detected object 201 along an opposite direction to the direction of the projected beam 211 to the ranging apparatus 200. The returned beam 212 reflected by the detected object 201 may be incident to the collimation element 204 after passing through the scanner 202.

The detector 205 and the emitter 203 may be arranged at a same side of the collimation element 204. The detector 205 may be configured to convert at least the part of the returned beam that passes through the collimation element 204 into an electrical signal.

In some embodiments, the optical elements may be coated with an anti-reflection film. In some embodiments, the thickness of the anti-reflection film may be equal to or close to a wavelength of the beam emitted by the emitter 203. The anti-reflection film may increase the intensity of the transmitted beam.

In some embodiments, a filter layer may be coated on a surface of an element of the ranging apparatus in the transmission path of the beam, or a filter may be arranged in the transmission path of the beam, which may be configured to transmit the light with a wavelength within the wavelength band of the beam emitted by the emitter and reflect the light of another wavelength band. Thus, the noise caused by environmental light may be reduced for the receiver.

In some embodiments, the emitter 203 may include a laser device. The light pulse in the nano-second level may be emitted by the laser device. Further, the reception time of the light pulse may be determined. For example, the reception time of the light pulse may be determined by detecting at least one of the ascending edge time or the descending edge time of the electrical signal pulse. For example, the ranging apparatus 200 may calculate the TOF by using the pulse reception time information and the pulse transmission time information to determine the distance between the detected object 201 and the ranging apparatus 200.

The ranging system of the present disclosure may include at least two ranging apparatuses. At least part of the at least two ranging apparatuses may emit the laser pulse sequence with different time sequences to cause intervals among emission times of the at least part of the at least two ranging apparatuses for emitting the laser pulses. As the flight time increases, power of the light pulse due to crosstalk of another ranging apparatus received by one ranging apparatus may be smaller. Thus, the probability of generating a crosstalk noise may be reduced correspondingly. After the one ranging apparatus receives the laser pulse, the flight time of the laser pulse may be measured by using the pulse emission time of the ranging apparatus as the basis. Therefore, for the received crosstalk light pulse signal, the time measured by the ranging apparatus is also changing. That is, the crosstalk noise caused by another ranging apparatus to the ranging apparatus may have different depths. The crosstalk may be easily eliminated through the algorithm.

The at least two ranging apparatuses included in the ranging system of the present disclosure may be set that the at least part of the at least two ranging apparatuses may emit different laser pulse sequences. Through such a setting, laser pulse sequences emitted by different ranging apparatuses may be distinguished to cause the different ranging apparatuses to receive the laser pulses emitted by themselves. Thus, the probability of generating the crosstalk noise may be reduced or eliminated.

The distance and orientation detected by the ranging apparatus 200 may be used for remote sensing, obstacle avoidance, surveying and mapping, modeling, navigation, etc. In some embodiments, the ranging apparatus of embodiments of the present disclosure may be applied to a mobile platform. The ranging apparatus may be mounted at a platform body of the mobile platform. The mobile platform having the ranging apparatus may perform measurement on the external environment. For example, a distance between the mobile platform and an obstacle may be measured to avoid the obstacle, and 2-dimensional and 3-dimensional surveying and mapping may be performed on the external environment. In some embodiments, the mobile platform may include at least one of an unmanned aerial vehicle (UAV), a vehicle (including a car), a remote vehicle, a ship, a robot, or a camera. When the ranging apparatus is applied to the UAV, the platform body may be a vehicle body of the UAV. When the ranging apparatus is applied to the car, the platform body may be a body of the car. The car may include an auto-pilot car or a semi-auto-pilot car, which is not limited here. When the ranging apparatus is applied to the remote vehicle, the platform body may be the vehicle body of the remote vehicle. When the ranging apparatus is applied to the robot, the platform body may be the robot. When the ranging apparatus is applied to the camera, the platform body may be a camera body.

Although exemplary embodiments have been described herein with reference to the accompanying drawings, described exemplary embodiments are merely exemplary, and are not intended to limit the scope of the present disclosure. Those of ordinary skill in the art may make various changes and modifications without departing from the scope and spirit of the present disclosure. All these changes and modifications are intended to be included in the scope of the present invention as claimed in the appended claims.

Those of ordinary skill in the art may be aware that the units and algorithm steps of the examples described in embodiments of the present disclosure may be implemented by electronic hardware or a combination of computer software and electronic hardware. Whether these functions are executed by hardware or software depends on the specific application and design constraint conditions of the technical solution. Those skilled in the art may use different methods for each specific application to implement the described functions, but such implementation should not be considered as going beyond the scope of the present disclosure.

In some embodiments of the present disclosure, the disclosed device and method may be implemented in another manner. For example, device embodiments described above are only illustrative. For example, the division of the units is only a logical functional division, and another division may exist in actual implementation, for example, a plurality of units or components may be combined or integrated into another device, or some features can be ignored or not implemented.

In the specification provided here, a lot of specific details are described. However, embodiments of the present disclosure may be practiced without these specific details. In some embodiments, well-known methods, structures, and technologies are not shown in detail. Thus, the understanding of this specification may not be obscured.

Similarly, to simplify the present disclosure and help understand one or more of the various aspects of the disclosure, in the description of exemplary embodiments of the present disclosure, the various features of the present disclosure may be sometimes grouped together into a single embodiment, a figure, or its description. However, the method of the present disclosure should not be interpreted as reflecting the intention that the claimed present invention requires more features than those explicitly stated in each claim. More precisely, as reflected in the corresponding claims, the point of the invention is that the corresponding technical problems can be solved with features that are less than all the features of a single disclosed embodiment. Therefore, the claims following specific embodiments are thus explicitly incorporated into the specific embodiments. Each claim itself serves as a separate embodiment of the present invention.

Those skilled in the art can understand that in addition to mutual exclusion between the features, all features disclosed in the specification (including the accompanying claims, abstract, and drawings) and all processes or units of any method or device disclosed in this manner can be combined by any combination. Unless expressly stated otherwise, each feature disclosed in this specification (including the accompanying claims, abstract, and drawings) may be replaced by an alternative feature providing the same, equivalent or similar purpose.

In addition, those skilled in the art may understand that although some embodiments described herein include certain features included in other embodiments but not other features, the combination of features of different embodiments means that they are within the scope of the present disclosure and form different embodiments. For example, in the claims, any one of the claimed embodiments may be used in any combination.

Various component embodiments of the present disclosure may be implemented by hardware, or by a software module that runs on one or more processors, or by a combination of the hardware and the software module. Those skilled in the art should understand that a microprocessor or a digital signal processor (DSP) may be used in practice to implement some or all of the functions of some modules according to embodiments of the present disclosure. The present disclosure may be further implemented as a device program (for example, a computer program and a computer program product) for executing a part or all of the methods described here. Such a program for realizing the present disclosure may be stored on a computer-readable medium or may include the forms of one or more signals. Such a signal may be downloaded from an Internet website, or provided in a carrier signal, or provided in any other forms.

The above-mentioned embodiments may be used to describe rather than limit the present disclosure. Those skilled in the art can design alternative embodiments without departing from the scope of the appended claims. In the claims, any reference signs located between parentheses should not be constructed as a limitation to the claims. The present disclosure may be implemented with the support of hardware including several different elements and a suitably programmed computer. In the unit claims listing several devices, several of these devices may be embodied in the same hardware item. The use of the words first, second, and third, etc. do not indicate any order. These words can be interpreted as names.

What is claimed is:

1. A ranging system comprising:
a plurality of ranging apparatuses each configured to emit a laser pulse sequence, receive a laser pulse sequence reflected by an object, and detect the object according to the laser pulse sequence emitted and the laser pulse sequence received;
wherein two or more ranging apparatuses of the plurality of ranging apparatuses are configured to emit laser pulse sequence with different time sequences and/or to emit different laser pulse sequences.

2. The ranging system of claim 1, wherein the two or more ranging apparatuses are configured to emit laser pulse sequence with different repetition frequencies to cause at least some of pulse emission times of the two or more ranging apparatuses to be staggered.

3. The ranging system of claim 1, wherein at least one of the plurality of ranging apparatuses is configured to emit laser pulse sequence with a random repetition frequency.

4. The ranging system of claim 1, wherein:
at least one of the plurality of ranging apparatuses is configured to emit laser pulse sequence with a same repetition frequency; and
at least another one of the plurality of ranging apparatuses is configured to emit laser pulse sequence with a random repetition frequency.

5. The ranging system of claim 1, wherein:
at least two of the plurality of ranging apparatuses are configured to emit laser pulse sequence with different repetition frequencies; and
at least another one of the plurality of ranging apparatuses is configured to emit laser pulse sequence with a random repetition frequency.

6. The ranging system of claim 1, wherein each of the plurality of ranging apparatuses is configured to emit laser pulse sequence with a random repetition frequency.

7. The ranging system of claim 1, wherein a time interval exists between an emission time of a laser pulse sequence of a first ranging apparatus of the plurality of ranging apparatuses and a detection window of a second ranging apparatus of the plurality of ranging apparatuses.

8. The ranging system of claim 7, wherein the time interval exists between the emission time of the laser pulse sequence of the first ranging apparatus and an emission time of a laser pulse sequence of the second ranging apparatus.

9. The ranging system of claim 8, wherein the time interval ranges from 1/10 to ½ of pulse repetition interval time of the plurality of ranging apparatuses.

10. The ranging system of claim 7, wherein a detection window of the first ranging apparatus is completely staggered from the detection window of the second ranging apparatus.

11. The ranging system of claim 1, wherein the plurality of ranging apparatuses include: at least two groups of ranging apparatuses, ranging apparatuses of different groups of the at least two groups are configured to emit laser pulse sequence with different wavelengths.

12. The ranging system of claim 11, wherein:
ranging apparatuses of a same group of the at least two groups are configured to emit laser pulse sequence with a same wavelength; or
different ones of the plurality of ranging apparatuses are configured to emit laser pulse sequence with different wavelengths.

13. The ranging system of claim 1, wherein the two or more ranging apparatuses are configured to emit laser pulse sequence with different pulse wave shapes.

14. The ranging system of claim 13, wherein the different pulse wave shapes include pulse wave shapes with at least one of different time-domain features, different pulse widths, or different modulation depths.

15. The ranging system of claim 1, further comprising:
a controller electrically connected to the plurality of ranging apparatuses and configured to control a time sequence of each of the plurality of ranging apparatuses.

16. The ranging system of claim 1, wherein each of the plurality of ranging apparatuses includes:
an emitter configured to emit the laser pulse sequence;
a scanner configured to change a transmission direction of the laser pulse sequence to different directions; and
a detection module configured to receive and convert at least part of return light of the laser pulse sequence reflected by the object into an electrical signal and determine a distance between the object and the ranging apparatus according to the electrical signal.

17. The ranging system of claim 16, wherein the scanner includes:
a first optical element and a driver connected to the first optical element and configured to drive the first optical element to rotate around a rotation axis to cause the first optical element to change a direction of the laser pulse sequence emitted by the emitter; and/or
a second optical element arranged oppositely to the first optical element and configured to rotate around the rotation axis.

18. The ranging system of claim 1, wherein each of the plurality of ranging apparatuses further includes:
a filter configured to filter return light of the laser pulse sequence reflected by the object to filter out at least part of light with a non-operational wavelength range.

19. A ranging system comprising:
a ranging apparatus configured to emit a laser pulse sequence, receive a laser pulse sequence reflected by an object, and detect the object according to the laser pulse sequence emitted and the laser pulse sequence received;
wherein the ranging apparatus is configured to emit the laser pulse sequence with a random repetition frequency and/or emit the laser pulse sequence after modulation.

20. A mobile platform comprising:
a first ranging system including:
a plurality of ranging apparatuses each configured to emit a laser pulse sequence, receive a laser pulse sequence reflected by an object, and detect the object according to the laser pulse sequence emitted and the laser pulse sequence received;
wherein two or more ranging apparatuses of the plurality of ranging apparatuses are configured to emit laser pulse sequence with different time sequences and/or to emit different laser pulse sequences; or
a second ranging system including:
a ranging apparatus configured to emit a laser pulse sequence, receive a laser pulse sequence reflected by an object, and detect the object according to the laser pulse sequence emitted and the laser pulse sequence received;
wherein the ranging apparatus is configured to emit the laser pulse sequence with a random repetition frequency and/or emit the laser pulse sequence after modulation.
